(19) United States
(12) Patent Application Publication
(10) Pub. No.: US 2010/0280908 A1
(43) Pub. Date: Nov. 4, 2010

(54) Method and System for Providing Targeted Advertisements and Messages to a User of an Activity Item List

(76) Inventors: Jennifer Bantrell Benz, Rockville, MD (US); Allen Thomas Benz, Boise, ID (US)

Correspondence Address: Jennifer Benz, 5102 Parklawn Terrace #302, Rockville, MD, 20852, US

(21) Appl. No.: 12/772,171

(22) Filed: Apr. 30, 2010

Related U.S. Application Data
(60) Provisional application No. 61/173,998, filed on Apr. 30, 2009.

(51) Int. Cl. G06Q 30/00

(52) U.S. Cl. 705/14.71; 705/26; 705/14.4

(57) ABSTRACT

A method and system that delivers advertisements and messages to a user of an activity item list is described. The method includes associating advertisements and messages with one or more activity items in the activity item list and making the advertisement and messages available to the user at a time of user interest and need. The method includes allowing the user to select an activity item list from a library of pre-defined lists. The user may announce progress on an activity to friends and others on a social network. The method includes allowing businesses and others to obtain the rights to have advertisements and messages associated with activity items.

### CROSS-REFERENCE TO RELATED APPLICATIONS

The present application incorporates by reference U.S. Provisional Patent Application No. 61173998 filed on Apr. 30, 2009 by the present inventors for “Method and System for Providing Targeted Advertisements and Messages to a User of an Activity Item List”.

### FEDERALLY SPONSORED RESEARCH

Not Applicable

### SEQUENCE LISTING OR PROGRAM

Not Applicable

### BACKGROUND

1. Field

The present invention relates generally to targeting and presenting advertisements and messages to consumers and users of activity item lists at an optimal time of interest and need. Examples of activity item lists include but are not limited to to-do lists, project plans, task lists, public or private events, and recipes.

2. Prior Art

Conventionally, a user of an activity list may track progress by marking started, in progress, and completed activities and tasks. The user may separately do research on possible solutions, vendors, and suppliers to use as part of completing an activity or task. The user may separately announce progress status to friends, colleagues, and family verbally or electronically by sending messages, having meetings, and discussion by phone.

Vendors and suppliers currently advertise by sending printed, email, and electronic message advertisements to lists of potential consumers and users. Because vendors and suppliers do not know if the consumer or user receiving the advertisement has any immediate or future need for their products, services, and solutions, these techniques result in very low response rates from the consumers and users. Vendors and suppliers also use search engine technologies to advertise to the consumers and users in the hope that a topic being searched by the consumer or user may indicate the current or future need for products, services, and solutions. Search engine advertising methods also result in low response rates.

Because these existing mechanisms deliver unneeded, unrelated and irrelevant advertisements to consumers and users, the user must spend time and effort researching products, services, and solutions to find useful alternatives. Often the user remains unaware of the existence of some products, services, and solutions that may be exactly what is necessary to complete the activity or task. What is needed is a means for vendors and suppliers to deliver optimal and most relevant advertisements and messages to the user that has the immediate and future interest and need for vendor supplied products, services, or solutions.

### SUMMARY OF THE INVENTION

A method for displaying and indicating progress on an activity item list with associated targeted advertisements is described. In some embodiments, the method includes selecting an activity item list from a template library of predefined activity item lists. The method includes sending status updates to friends and others in one or more social networks. Business and other users can create custom activity item lists and manage targeted advertisements associated with activity items and collections of activity items.

### BRIEF DESCRIPTION OF THE DRAWINGS

FIG. 1 is a block diagram of an exemplary activity item list management provider;

FIG. 2 is a block diagram of an exemplary activity item list engine; and

FIG. 3 is an exemplary screen shot of an activity item list and targeted advertisements displayed to the consumer user. Additionally FIG. 3 shows an exemplary activity item status update being sent to friends and others on one or more social networks.

### DETAILED DESCRIPTION

A system and method for indicating and displaying progress of activities in an activity item list, viewing advertisements associated with activity items, and sending status updates to friends and others in one or more social networks is provided. The consumer user may choose an activity list from a library of predefined activity item lists and indicate progress on individual activity items or groups of activity items. Advertisements and messages associated with individual and groups of activity items are displayed to the consumer user to allow the business user to offer products, services, and solutions for the activity. When the consumer user indicates progress on an activity item, the consumer user has the option to send a message to friends and others on a social network or other messaging services. As a result, the friends and others may be better able to follow the progress of the consumer user on completion of the activity item list. An advertising commerce exchange allows the business user to purchase and bid for advertising opportunities on the activity item lists. The business user can also create custom activity item lists and specify advertisements for the activity items. The business user may offer opportunities to advertise for activity items for bid or purchase to other business users.

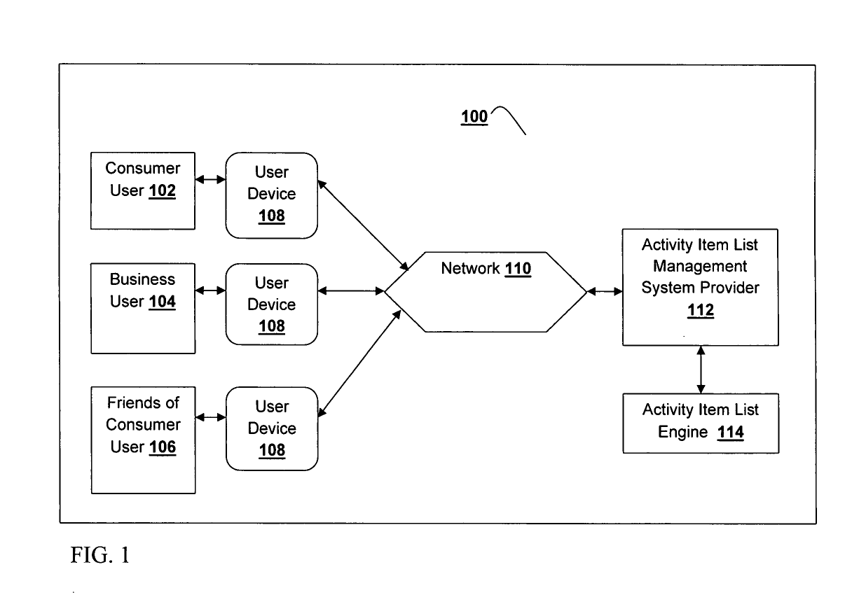

FIG. 1 illustrates an exemplary environment 100 for delivering advertisements and messages to a consumer user reporting progress on an activity item list. One or more consumer users, such as a consumer user 102 at a user device 108, are connected to an activity item list management provider 112 via a network 110. One or more business users, such as a business user 104 at a user device 108 and one or more friends of consumer user, such as a friends of consumer user 106 at user device 108 are connected to the activity item list management provider 112 via the network 110. The activity item list management system provider 112 may host a website, application, or other connection service that allows one or more consumer users 102, at one or more user devices 108, to manage individual instances of activity item lists. The activity item list management system provider 112 uses an activity item list engine 114 to supply services to the consumer user 102, the business user 104, and the friends of consumer user 106.

In one instance, the consumer user 102 associated with the user device 108 selects a predefined activity item list from a predefined library. Once selected by the consumer user 102, the activity item list engine 114 makes a copy of the predefined activity item list specifically for the consumer user 102 to use. Some embodiments allow the consumer user 102 to customize the copy of the activity item list by adding and deleting additional activity items and activity item categories.

In one instance, the consumer user 102 associated with the user device 108 marks an activity item status as complete. The completion status and message is optionally sent to the friends of consumer user 106 as a means of announcing and tracking progress within a social network community. Some embodiments allow the consumer user 102 to customize a status message prior to the message being sent to the friends of consumer user 106. Some embodiments send activity progress reminders and alerts to the consumer user 102.

In one instance, the business user 104 associated with the user device 108 purchases the rights to place an advertisement on an activity item in an activity item list. Once associated with the activity item, the advertisement is displayed to the consumer user 102 by the activity item list engine 114. Some embodiments allow the business user 104 to purchase or bid for the rights to place advertisements on multiple activity items, multiple activity item categories, and entire lists. Some embodiments allow multiple advertisements to be placed on a single activity item with preference for placement order. Some embodiments send advertising opportunity reminders to the business user 104.

The activity item list engine 114 is connected to the activity item list management provider 112. The activity item list engine 114 manages data associated with one or more activity item lists for the consumer user 102, data associated with bidding and purchase of advertising rights for the business user 104, and interfaces to social network solutions to the friends of consumer user 106.

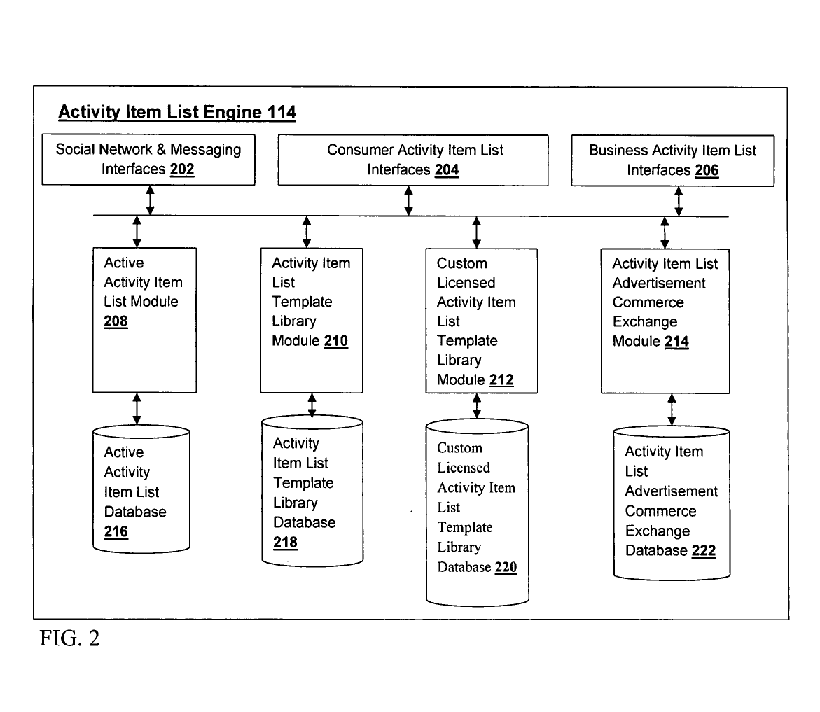

FIG. 2 is a block diagram of an exemplary activity item list engine such as the activity item list engine 114 shown in FIG. 1. The activity item list engine 114 includes interfaces, modules, and databases. According to some embodiments, the activity item list engine 114 connects with the activity item list management system provider 116. According to other embodiments, the consumer user 102, the business user 104, and the friends of consumer user 106 may connect via one or more of the user device 108 to the activity item list engine 114.

A consumer activity item list interfaces 204 provides user interfaces and data interfaces to the consumer user 102. Embodiments of the consumer activity item list interfaces 204 include but are not limited to web sites, web site components, web parts, portlets, web services and mobile applications.

A business activity item list interfaces 206 provides user interfaces and data interfaces to the business user 104. Embodiments of the business activity item list interfaces 206 include but are not limited to web sites, web site components, web parts, portlets, web services and mobile applications.

A social network & messaging interfaces 202 allows the consumer user 102 to publish the status of activity item list items and progress to friends of consumer user 106 and members of, but not limited to, social networks, texting address lists, email address lists, and instant messaging lists. The customizable information sent via these interfaces is stored in an active activity item list database 216.

An active activity item list module 208 manages individual instances of activity item lists selected by the consumer user 102. The consumer user 102 may have one or more current activity item lists of various types. Completed activity item lists are also managed by the active activity item list module 208.

An active activity item list database 216 stores information managed by active activity item list module 208. This information includes but is not limited to activity item list names, categories, and items; text, images, and links to advertisements; status; priority; and customizable message text to send to friends of consumer user 106 and members of, but not limited to, social networks, texting address lists, email address lists, and instant messaging lists.

An activity item list template library module 210 manages a library of activity item list templates selectable by the consumer user 102. The consumer user 102 may select one or more activity item lists of various types from the activity item list template library.

An activity item list template library database 218 stores information managed by activity item list template library module 210. This information includes but is not limited to activity item list names, categories, and items; text, images, and links to advertisements; status; priority; and customizable message text to send to friends of consumer user 106 and members of, but not limited to, social networks, texting address lists, email address lists, and instant messaging lists.

A custom licensed activity item list template library module 212 manages a library of activity item list templates selectable by the consumer user 102 and licensable by the business user 104. The consumer user 102 may select one or more activity item lists of various types from the custom licensed activity item list template library. The business user 104 can create, edit, and delete custom activity item lists, activity item list categories, and activity items. The business user 104 can also manage information including but is not limited to activity item list names, categories, and items; text, images, and links to advertisements; status; priority; and customizable message text to send to friends of consumer user 106 and members of, but not limited to, social networks, texting address lists, email address lists, and instant messaging lists.

A custom licensed activity item list template library database 220 stores information managed by the custom licensed activity item list template library module 212. This information includes but is not limited to activity item list names, categories, and items; text, images, and links to advertisements; status; priority; and customizable message text to send to friends of consumer user 106 and members of, but not limited to, social networks, texting address lists, email address lists, and instant messaging lists.

An activity item list advertisement commerce exchange module 214 allows the business user 104 to bid, pay after winning the bid, and pay without bidding for preferred placement of the business user 104 advertisements on individual activity list items, on individual activity list categories, and on whole activity item lists.

An activity item list advertisement commerce exchange database 222 stores information managed by the activity item list advertisement commerce exchange module 214. This information includes but is not limited to availability of advertisement opportunities, date and duration of auction, minimum starting bid, current bid, final bid, payment amount, payment status, business user name and identifying information, text, images, links to advertisements, and interfaces to other advertisement systems.

In one instance, using the business activity item list interfaces 206, the business user 104 views the collection of activity item lists managed by the activity item list template library module 210 and the opportunities to bid for preferred placement of advertisements. Once the business user 104 has placed a bid and won the auction against other business users, the business user 104 submits advertisement information including but not limited to text, images, advertisement links, and interfaces to other advertisement systems. The advertisement information is stored in the activity item list template library database 218 and is associated with the activity item list item or list category or the entire list as per the offering of the auction. The business user 104 can alternatively purchase without bidding for preferred placement of advertisements. Other embodiments update advertising information submitted by the business user 104 in all active activity items managed by the active activity item list module 208. Other embodiments send alerts and reminders to the business user 104 about advertising opportunities for current and new activity item lists and activity items.

In one instance, using the consumer activity item list interfaces 204, the consumer user 102 views the collection of activity item lists managed by the activity item list template library module 210 and selects one or more activity item lists. Once selected, the active activity item list module 208 makes copies of the activity item lists for the consumer user 102 into the active activity item list database 216. The advertisements promoted by the business user 104 are viewable and selectable by the consumer user 102 in the active activity item list. The active list module 208 tracks any advertisement link selection by the consumer user 102 and a report is viewable by the business user 104 via the business user interfaces 206.

In one instance, using the consumer activity item list interfaces 204, the consumer user 102 views and updates the copy of the active activity list items, marking items with an indicator, such as a checkmark. Once selected and marked, the active activity item list module 208 displays the message to be sent to the friends of consumer user 106 and members of, but not limited to, social networks, texting address lists, email address lists, and instant message lists. Other embodiments allow the consumer user 102 to modify the message before sending it. Other embodiments allow the message to be sent automatically without first displaying it to the consumer user 102.

In one instance, using the business activity item list interfaces 206, the business user 104 can create, edit, and delete custom and licensed collections of activity item lists. The custom licensed activity item lists are managed by the custom licensed activity item list template library module 212. The business user 104 can submit and manage a list of advertisements associated with activity item list items, activity item list item categories, and activity item lists. Both the advertisements and the custom licensed activity item lists are stored in the custom licensed activity item list template library database 220.

In one instance, using the consumer activity item list interfaces 204 or being redirected by the website of business user 104, the consumer user 102 views the custom licensed collection of activity item lists managed by the custom licensed activity item list template library module 212 and selects one or more activity item lists. Once selected, the custom licensed active activity item list module 212 makes copies of the activity item lists for the consumer user 102 into the active activity item list database 216. The custom advertisements promoted by the business user 104 are viewable and selectable by the consumer user 102 in the active activity item list. The active activity item list module 208 tracks advertisement link selection by the consumer user 102 and a report is viewable by the business user 104 via the business user interfaces 206.

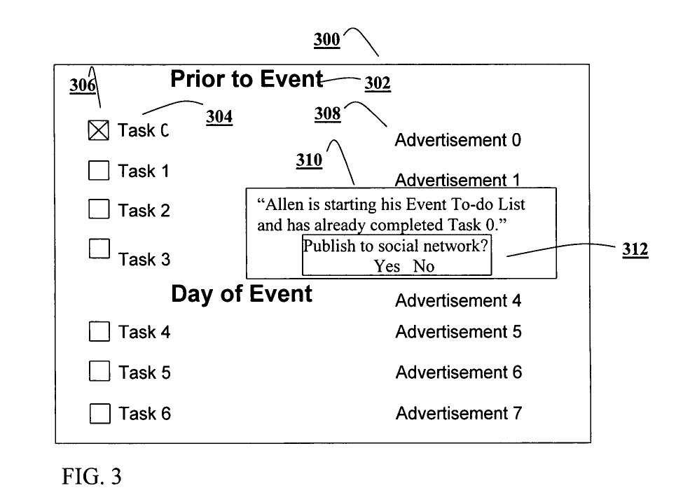

FIG. 3 is an exemplary screen shot 300 of an activity item list consisting of one or more activity items 304, a selectable progress indicator 306, and an associated advertisement 308 displayed to the consumer user 102. The exemplary screen shot 300 represents a display page showing four tasks as activity items in an activity category named “Prior to the Event” and three tasks as activity items in an activity category named “Day of the Event”. More or fewer activity items 304 and activity categories 302 may be displayed.

The advertisement 308 associated with the activity item 304 is displayed to the consumer user 102. The advertisement 308 may be a message or an informational link or a combination of a message and an informational link that the consumer user 102 can read or select to find information of related products, services, and solutions relevant to the activity item 304. Other embodiments may have the advertisement 308 associated with the activity item category 302. Other embodiments may have more than one advertisement 308 associated with the activity item 304 and the activity item category 302.

The activity item 304 has the selectable progress indicator 306 for the consumer user 102 to mark and display progress. In the exemplary screen shot 300, the selectable progress indicator 306 is shown as an ‘X’ in a selection box indicating a status of task completion. When the consumer user 102 selects the box, an ‘X’ is inserted and a message box 310 is displayed. The exemplary message box 310 shows a message “Allen is starting his Event To-do List and has already completed Task 0”. A selectable button 312 allows the consumer user 102 to decide whether to publish and send the message to the friends of consumer user 106 on a social network. Other embodiments allow the consumer user 102 to change the message prior to sending it to the friends of consumer user 106.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed for carrying out this invention, but that the invention will include all embodiments falling within the scope of the appended claims.

1. A method for displaying an activity item list, the method comprising: creating and selecting an activity item list from a template library; attaching and viewing content associated with a plurality of activity items; marking status on a plurality of activity items; sending activity item status updates to other users of a social network or message system; bidding and purchasing rights to attach content associated with a plurality of activity items.

2. The method of claim 1 wherein said content comprises advertisement informational links and advertisement messages.

3. The method of claim 2 wherein said advertisement is for a product, service, or solution.

4. A system for displaying an activity item list, the system comprising: an activity item list environment; an active activity item list module and database configured to manage separate copies of activity item lists associated with a consumer user of the activity item list environment; an activity item list template library module and database configured to manage multiple templates of activity item lists that can be selected by the consumer user of the activity item list environment, generating a copy of the selected template into an active activity item list associated with the consumer user; a custom licensed activity list template library module and database configured for business users to manage multiple custom templates of activity item lists that can be selected by the consumer user of the activity item list environment, generating a copy of the selected custom template into an active activity item list associated with the consumer user; an activity item list commerce exchange module and database configured to allow multiple business users to bid, purchase, and exchange advertisement opportunities associated with activity item lists; a consumer user activity item list interface configured to allow interaction with a consumer user of the activity item list system environment; a business user activity item list interface configured to allow interaction with a business user of the activity item list system environment; and a social network and messaging interface configured to allow a consumer user to manage announcement of progress and status of the activity items and to allow a business user to manage announcement of advertisements and custom activity list templates.

5. A computer readable medium having embodied thereon a program, the program being executable by a processor for performing a method for displaying an activity item list, the method comprising: selecting an activity item list from a template library; viewing attached advertisement informational links and messages associated with one or more activity items; marking status on one or more activity items; and sending status updates to other users of a social network.
